(19) United States
(12) Patent Application Publication
(10) Pub. No.: US 2020/0024164 A1
(43) Pub. Date: Jan. 23, 2020

(54) SYSTEM AND METHOD TO CONDITION PROCESS WASTE WATER FOR TREATMENT

(71) Applicant: ClearCove Systems, Inc., Victor, NY (US)

(72) Inventors: Terry Wright, Rochester, NY (US); Michael Alan Butler, Webster, NY (US)

(73) Assignee: ClearCove Systems Inc., Victor, NY (US)

(21) Appl. No.: 16/038,290

(22) Filed: Jul. 18, 2018

(51) Int. Cl. C02F 1/66; C02F 1/44; B01D 21/00

(52) U.S. Cl. CPC C02F 1/66; C02F 1/444; B01D 21/0006; B01D 61/025; C02F 2209/06; C02F 2209/11; C02F 2209/02

(57) ABSTRACT

A method to accumulate and pre-treat waste water prior to further processing. The method comprises accumulating waste water in a first and second tank and selectively adding further influent waste water to the first or second tank to such that the resultant pH from combining the influent waste water with the accumulated waste water results in a pH close to a target pH.

### FIELD OF THE APPLICATION

The present invention is directed to systems for treatment of waste water; more particularly, to systems for removing solids and solvated materials from municipal, agricultural, industrial, and mining waste water streams, e.g., a food process waste water stream; and most particularly to a system for the conditioning of waste water to increase the performance of downstream processes and equipment used to treat the waste water.

### BACKGROUND OF THE INVENTION

The inventor has developed waste water treatment systems incorporating EPT's (Enhanced Primary Treatment Systems), decanters, filtration subsystems, and controls for the same. These have been shown to be extremely effective in separating constituents from an influent waste water stream and delivering clean water for re-use or return to the environment. Exemplary embodiments of EPT's and decanters are disclosed in U.S. Pat. No. 8,398,864, “Screened Decanter Assembly”, U.S. Pat. No. 9,643,106 “Screen Decanter for Removing Solids from Wastewater”, U.S. Pat. No. 9,744,482 “Screen decanter for Screening Solids from Waste Water”, U.S. Pat. No. 9,782,696 “Method for Maximizing Uniform Effluent Flow Through a Waste Water Treatment System”, U.S. Pat. No. 9,855,518, “Method and Apparatus for a Vertical Lift Decanter System in a Water Treatment Systems”, U.S. Pat. No. 9,908,067 “Floatables and Scum Removal Apparatus”, U.S. patent application Ser. No. 14/874,396 “Improved System for Mixing Industrial Waste Water within a Gravity Settling Tank”, U.S. patent application Ser. No. 14/874,400 “Improved Method for Mixing Industrial Waste Water Within a Gravity Settling Tank”, U.S. patent application Ser. No. 15/887,987 (hereinafter the '987 application) “Improved System and Method for Static Mixing in a EPT using a Fluid Containment Assembly”, U.S. patent application Ser. No. 15/955,803 (hereinafter the '803 application) “Improved System and Method for Static Mixing in a EPT using a Fluid Containment Assembly” and U.S. patent application Ser. No. 14/471247 “Method and Apparatus for Using Air Scouring of a Screen in a Water Treatment Facility”, all of which are incorporate in their entirety for all purposes herein. Exemplary embodiments of system combining EPT's, decanters, and filtration systems to treat waste water are disclosed in pending U.S. patent application Ser. No. 15/956,809 “Improved System and Method for Separating Nutrients from a Waste Stream” and pending U.S. patent application Ser. No. 15/897,750, “Improved Method for Processing Wastewater”, all of which are incorporated in their entirety for all purposes herein.

For virtually all waste water treatment applications, but particularly for the food and beverage industry, there is a need to accommodate variability both in the flow rate and composition of the waste water influent. The flow rate and composition can vary from product run to product run, shift to shift, diurnally, day to day, and season to season. Influent characteristics, such as pH, organic content and suspended particle size distributions also vary widely. Organic content is commonly characterized using measurements of any of BOD (Biological Oxygen Demand), COD (Chemical Oxygen Demand), TOC (Total Organic Carbon) and TSS (Total Suspended Solids).

While such waste water treatment systems are highly effective, their performance and throughput can be improved by conditioning, or pre-treating, the waste water before first processing it with the EPT. In practical terms it is necessary to design a waste water treatment system that can operate robustly with influent waste streams that have constantly changing flow rates, composition and other physical characteristics such as temperature and pH.

By way of example, the effectiveness of coagulants and flocculants used to settle materials in the EPT may be pH sensitive. The pH of industrial waste streams such as from a food processing plant may commonly vary from 4 to 12, a span of 8 pH units, while the optimum pH range for effectiveness of coagulants and flocculants, is more typically 3-4 pH units. In certain circumstances, it may be further necessary to control the pH range to 0.5 to 1 pH unit to minimize discharge of coagulants, flocculants or waste stream materials from the EPT that can deleteriously impact water treatment system elements downstream of the EPT.

While the adjustment of pH for a solution containing a simple mixture of acids or bases is well understood, predictable and rapid pH adjustment for a complex mixture of chemicals and foodstuffs is far more complex. Specifically, in typical applications the buffering capacity of a waste stream may result in the need to add 100 or more times as much acid or based for to adjust the pH as would be required to adjust the same volume of solution containing a strong or moderate acid/base. In real applications the buffering capacity of the waste stream being treated may change by factors of tens over the course of days, hours or even minutes as the plant processes different foods and beverages and cleans the food processing equipment using mixtures of acids, bases and sanitizing chemicals.

A further problem arises when the plant discharges waste water with a composition or physical characteristic, e.g., pH, total solids content, outside the operating range within which the waste water treatment system can operate. Such situations, “calamity events”, require the ability to isolate the waste stream during the event.

Thus, a buffering and pre-conditioning system is required between the waste water influent and the EPT tanks. By employing two or more EQ (equalization) tanks in conjunction with sensors and a control system, it is possible to significantly improve the overall performance of the waste water treatment system. With two or more EQ tanks in use, this provides several hours for mixing and pH balancing while wastewater from another tank is being processed. Thus mixing/balancing can be accomplished using smaller pumps and motors than with other chemical doping strategies.

### SUMMARY OF THE INVENTION

A method to accumulate and pre-treat waste water prior to further processing. The method comprises accumulating waste water in a first equalization tank and a second equalization tank and selectively adding further influent waste water to the first or second tank to such that the resultant pH from combining the influent waste water with the accumulated waste water results in a pH close to a target pH. The method of further comprising the steps of measuring a property of said waste water; establishing a target range for the value of said first property, said target range having a lesser value and a greater value, adding the waste water to a designated tank if said value of said property is greater than said greater value.

A method to accumulate waste water for further processing, the method comprising starting the accumulation of said waste water in a first equalization tank at a first time and the accumulation of said waste water in a second equalization tank at a second time; measuring the fluid level and pH of said first equalization tank accumulated waste water and the fluid level and pH of said second equalization tank accumulated waste water; establishing a target pH; measuring the pH of said waste water; adding said waste water to said first equalization tank and said second equalization tank according to decision criteria intended to adjust the pH of said first equalization tank accumulated waste water and said second equalization tank accumulated waste water to a value near the target pH; monitoring a first holding time calculated as the current time minus the first time and halting the accumulation of said waste water in said first equalization tank if said first holding time exceeds a first time threshold.

### BRIEF DESCRIPTION OF THE DRAWINGS

FIG. 1 provides an overview of a waste water treatment system 10 in accordance with the instant application

FIG. 2 provides and overview of an influent delivery system and an EPT in accordance with the instant application.

FIG. 3 provides an overview of a waste water pre-conditioning system 110 comprising equalization tanks and a calamity tank in accordance with the instant application.

FIG. 4 provides an overview of a method to pre-condition the waste water influent stream in accordance with the instant application.

### DETAILED DESCRIPTION OF THE INVENTION

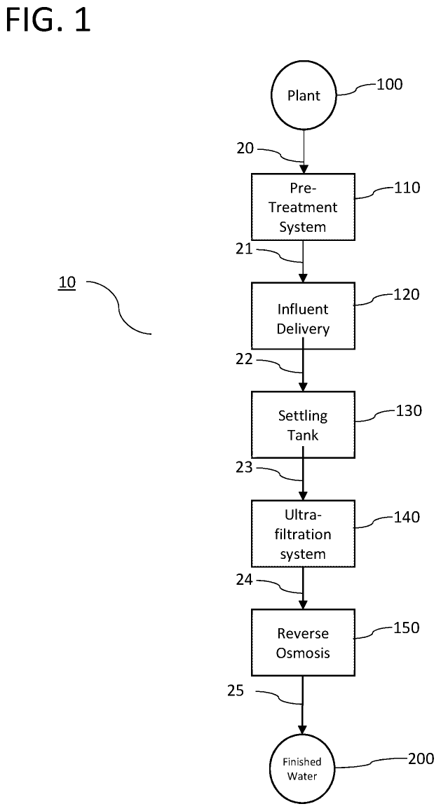

With reference to FIG. 1, in a preferred embodiment of the instant application, a waste water treatment system 10 comprises pre-treatment system 110 for receiving process waste water 20 discharged from plant 100. An influent delivery system 120 is in fluid communication with pre-treatment system 110 and settling tank 130 to transfer process waste water 21 from pre-treatment system 110 to settling tank 130. Optionally, influent delivery system 120 further comprises means for addition of coagulants and/or flocculants to enhance coalescence and settling of solids in the settling tank 130. In a currently preferred embodiment influent delivery system 120 is substantially similar to the influent delivery system disclosed in the '987 application.

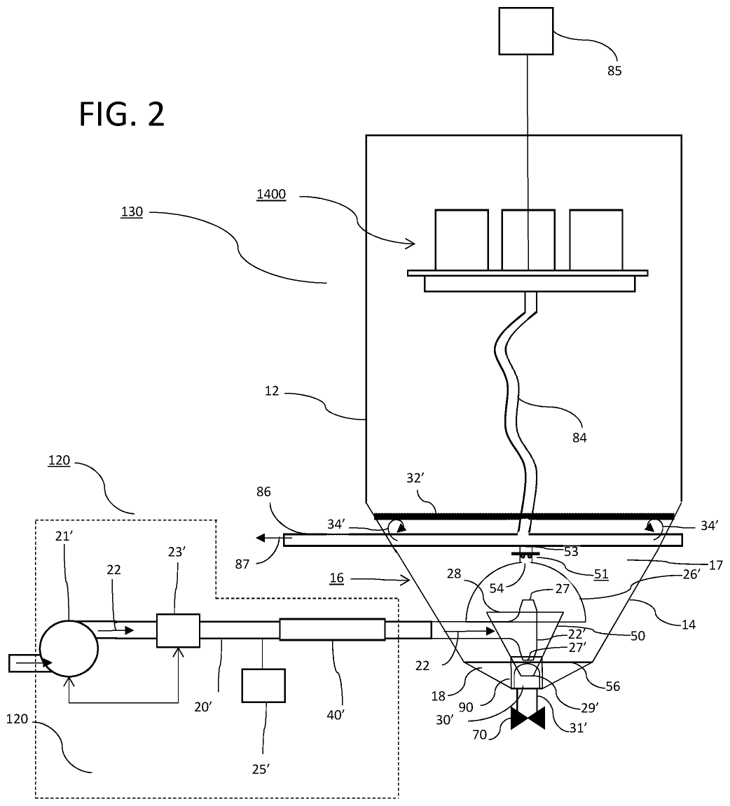

With reference to FIG. 2, and as described in more detail in the '987 application, in a currently preferred embodiment influent delivery system 120 comprises pump 21′ controlled by flow control apparatus 23′ which may include a flow meter and control valving (not shown) in known fashion. Further, dosing apparatus 25′ may be provided for, e.g., adjusting pH of the influent or adding coagulants and/or flocculants thereto. In a currently preferred embodiment, influent pipe 20′ further includes an inline static mixer 40′, such as for example a helical auger, arranged to provide mixing of coagulants and/or flocculants with the influent stream.

Continuing with FIG. 1, settling tank 130 is in fluid communication with ultrafiltration (UF) system 140 and arranged to transfer the supernatant 23 resulting from settling solids out of the process waste water 22. Ultrafiltration system 140 is in fluid communication with reverse osmosis (RO) system 150 and arranged to transfer the U.F. filtrate 24 to RO system 150 for filtration. Reverse osmosis system 150 permeate 25 is discharged from system 10 as finished water 200.

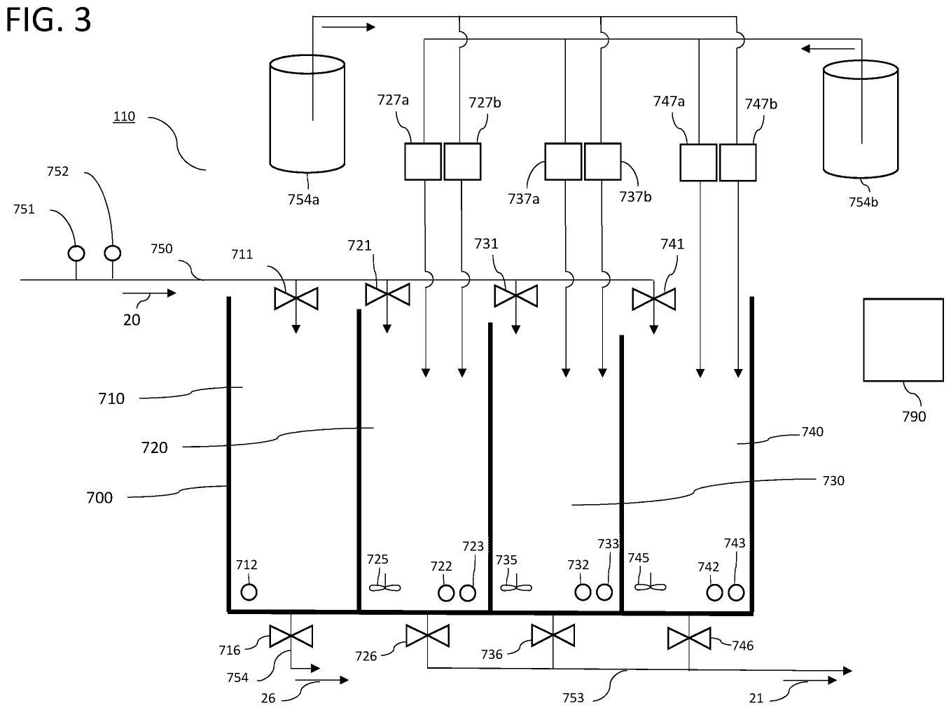

Referring now to FIG. 3, in a preferred embodiment pre-treatment system 110 comprises a calamity tank 710 and three equalization tanks 720, 730, 740. The calamity tank 710 and equalization tanks are arranged to receive process waste water 20 from plant 100 (Reference FIG. 1) via pipe 750. Valves 711, 721, 731 and 741 control delivery of process waste water 20 to tanks 710, 720, 730 and 740 respectively. In a preferred embodiment valves 711-741 are automatically controlled by controller 790. Communication between controller 790 and valves 711, 721, 731, 741 may be via ethernet, twisted wire pair, RS-232, wireless (not shown) or any other suitable communications means. It is to be further understood that other elements of this instant application described hereinafter as in communication with controller 790 may similarly be in communication via ethernet, twisted wire pair, RS-232, wireless (not shown) or any other suitable communications means. Sensor 751, in communication with controller 790, is arranged to measure the pH and optionally the temperature of process waste water 20 in pipe 750.

Optional sensor 752, in communication with controller 790, is arranged to measure one or more properties of process waste water 20 in pipe 750 to detect a calamity event. As used hereinafter, a calamity event arises when one or more properties of process waste water 20 lies outside the operating range for treatment by system 10.

In a currently preferred embodiment, optional sensor 752 measures the extinction coefficient of ultra-violet light, preferably at 254 nm. As is well known in the art, the extinction coefficient of ultraviolet light, and particularly the extinction coefficient at 254 nm, can be correlated to chemical oxygen demand, total organic carbon and biological oxygen demand. Optional sensor 752 may alternatively, or additionally, measure total suspended solids, turbidity or other physical and chemical properties of the process waste water in accordance with the instant application as described in more detail hereinafter.

Each of tanks 710, 720, 730 and 740 has a level sensor, 712, 722, 732 and 742 respectively, said level sensors in communication with controller 790. Tanks 720, 730 and 740 further have sensors 723, 733 and 743 respectively to measure pH and optionally temperature, said sensors in communication with controller 790. Tanks 720, 730 and 740 also have mixers 725, 735 and 745 respectively, said mixers in communication with and controlled by controller 790. In a currently preferred embodiment said mixers 725, 735 and 745 are variable speed mixers, and more preferably, operated via a variable frequency drive (VFD), not shown, in communication with controller 790, to control their mixing speed.

Process waste water 21 is delivered from equalization tanks 720, 730, 740 via pipe 753 to settling tank 130. Each equalization tank, 720, 730 and 740 is controllably in fluid communication with pipe 753 via valves 726, 736 and 746 respectively, said valves 726, 736 and 746 under the control of controller 790. Process waste water 26 from calamity tank 710 is discharge with pipe 754 via valve 716, said valve optionally in communication with and under the control of controller 790.

Two dosing pumps are arranged to adjust the pH in each of the equalization tanks. 720, 730, and 740. One dosing pump doses with acid and to lower the pH and one dosing pump doses with base to raise the pH. The dosing pumps are in communication with and under the control of controller 790. The acid and base dosing pumps for tank 720 are 727a and 727b respectively. The acid and base dosing pumps for tank 730 are 737a and 737b respectively. The acid and base dosing pumps for tank 740 are 747a and 747b respectively. The acid dosing pumps 727a, 737a and 747a draw acid from acid storage tank 754a. The base dosing pumps 727b, 737b and 747b draw base from base storage tank 754b.

An important aspect of the instant application is that operation of the waste water treatment system 10 must not interfere with or limit the operation of the plant 100. Accordingly, waste water treatment system 10 must always be able to receive process waste water 20 from plant 100. In practice this requires the waste water treatment system 10 to receive process waste water 20 over a wide range of parameters including without limitation, hourly discharge volume, pH, total suspended solids, organic content and mix of specific constituents, e.g., proteins, fats, solids, alcohols. By way of example, in a representative application, discharge volumes for normal plant operation may range from 1,000 to 10,000 gallons per hour, pH from 4 to 12 and total suspended solids from 100 to 4000 mg/l. A particular challenge is that the process waste water may vary unpredictably from day to day as plant production varies to meet customer orders.

While water treatment system 10 is required to receive process waste water 20 under a broad range of circumstances, optimal treatment of the process waste water via settling tank 130, ultrafiltration system 140 and reverse osmosis apparatus 150 requires the properties of process waste water 21 discharged from pre-treatment system 110 to fall within narrower limits. Pre-treatment system 110 is used to adjust one or more chemical and/or physical characteristics of the accumulated process waste water 20 before further processing by the waste water treatment system 10.

Additionally, it is important that the waste water treatment system 10 can receive process waste water 20 when exceptional and unpredictable events occur within the plant, e.g.: accidental discharge of cleaning chemicals or raw food stock; or, dumping of finished product with unacceptable quality. During exceptional events, the pre-treatment system may not be able to adjust the process waste water 20 to make it suitable for further treatment. In operation, as process water 20 is delivered to the pre-treatment system 110, sensor 752 and optionally sensor 751 are used to monitor one or more properties of the process waste water 20. If the properties of the process waste water 20 are outside the limits within which the pre-treatment system can operate, such as during an exceptional plant event, controller 790 opens valve 711 to divert the process waste water 20 to calamity tank 710. When the properties of the process waste water 20 are again within the operating limits of the pre-treatment system, the process waste water is delivered to one of the equalization tanks, 720, 730 or 740 as described in more detail herein.

In one representative embodiment, sensor 752 comprises a spectrophotometer to measure absorption and/or scattering of electromagnetic radiation by the process waste stream. In one exemplary embodiment the spectrophotometer comprises a UVAS (ultraviolet absorption spectrophotometer) to measure absorption of electromagnetic radiation with a wavelength of 254 nm, which measurement is correlated to one or more of BOD, COD, and TOC. In another exemplary embodiment the spectrophotometer measures scattering of electromagnetic radiation with a wavelength of 880 nm, which measurement is correlated with TSS.

In a preferred embodiment, pre-treatment system 110 adjusts the pH of process water received in tanks 720, 730 and 740 to optimize settling of solids in the settling tank 130 and minimize discharge of metals used in coagulants added to the process waste water 22 by the influent delivery system as described in more detail in the '987 application. Metal ions, such as aluminum found in aluminum polychlorohydrate, can foul reverse osmosis systems. Therefore, it is desirable to adjust the pH of the process water 21 to minimize the solubility and discharge of these metal ions from the settling tank 130. In a currently preferred embodiment, it is desirable to adjust the pH of process waste water accumulated in equalization tanks 720, 730 and 740 to a value between 6.5 and 7.0.

Methods to adjust the pH of simple solutions of acids and bases are well known to those skilled in the art. However, process waste water emitted from a typical food or beverage processing plant includes a complex and constantly changing combination of materials that includes food stuffs and chemicals used to clean and sanitize the plant food process equipment and the plant structures (e.g., floors and walls). Exemplary chemicals used to clean and sanitize include without limitation, sodium hydroxide, sulfuric acid, acetic acid, nitric acid, peracetic acid, hydrogen peroxide, sodium hypochlorite, sodium carbonate, phosphoric acid, detergents, surfactants, chelating agents and the like. The resulting combination of materials produces a process waste stream with highly variable pH buffering capacity. As a result the amount of acid or base required to adjust the pH is not readily determinable from a simple measurement of the pH and is typically much larger than would be required to adjust the pH of the same volume of a simple solution of a strong acid or a strong base.

An example: A tank containing 20,000 gallons of fluid consisting solely of a solution of hydrochloric acid at a pH of 4 would require approximately 0.4 gallons of commercially available 50% caustic (19.4 Molar) to adjust the pH of the solution to a value of 7. By way of comparison, in a representative application the buffering capacity of process water with a pH 4 under normal plant operating conditions requires between 5 and 60 gallons of 50% caustic to adjust the pH. Comparable results are found when adjusting the pH of basic process waste water.

The large total amount of chemicals and the large potential variability for the total amount of acid or base to adjust the pH are both undesirable. A large total amount of chemicals contributes to higher chemical consumption and operating costs. A large range in the total amount of chemicals potentially required to adjust pH contributes to higher capital costs to procure higher speed dosing pumps in order to minimize the amount of time required to adjust pH and maintain plant throughput. To reduce chemical costs, capital costs and improve plant throughput a better solution is to take advantage of the fluctuations in pH of the process water 20 discharged from plant 100 to adjust the pH of the process water 20 accumulated in equalization tanks 720, 730, 740.

This presents several challenges. The pH of the process waste water 20 varies unpredictably, as does its buffering capacity. An equalization tank must always be available to accept process waste water 20 from plant 100 so as not to impact production. As the process for startup and shutdown of the ultrafiltration system and RO apparatus is complex, when the waste water treatment system is in operation, it is important to have an equalization tank holding process water with adjusted pH available for influent delivery system 120 to circulate through the waste treatment system 10. Lastly, it is undesirable to retain process waste water 20 accumulated in an equalization tank for extended periods of time before being treated as biological activity will result in objectionable odors and the production of byproducts that can have an undesirable impact on the performance of the waste water treatment system 10. In additional chemical activity, such as from enzymes and interactions with cleaning chemicals can change the pH and alter the chemical composition of the accumulated process waste water in the equalization tank requiring changes in the operational settings of the waste water treatment system 10.

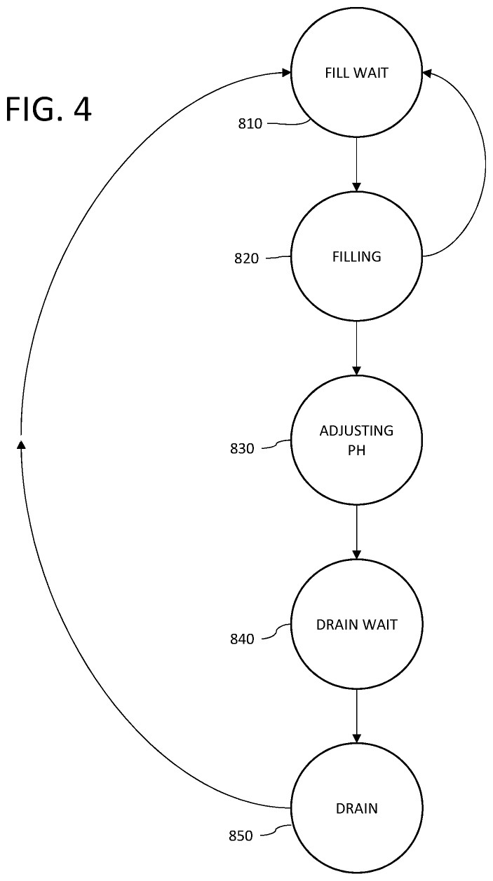

In operation the three equalization tanks 720, 730, 740 are individually cycled through the states identified with reference to FIG. 4 and described in more detail in Table 1.

TABLE 1
Equalization Tank State Descriptions

| Identifier | State Name | Description |
|---|---|---|
| 810 | FILL WAIT | The equalization tank is |
| | | available to be filled. |
| 820 | FILLING | The equalization tank is |
| | | actively being filled |
| 830 | ADJUSTING PH | system 110 is adjusting the pH |
| | | of the equalization tank using |
| | | the chemical dosing pumps. |
| | | E.g., equalization tank 720 pH |
| | | is adjusted using dosing pumps |
| | | 727a and 727b. |
| 840 | DRAIN WAIT | The equalization tank is |
| | | waiting to be drained |
| 850 | DRAINING | The equalization tank is being |
| | | drained via influent delivery |
| | | system 120. |

Under typical operating conditions an equalization tank cycles from state 810 FILL WAIT to 820 FILLING to 830 ADJUSTING PH to 840 DRAIN WAIT to 850 DRAINING and returns to state 810 FILL WAIT according to pre-determined state transition criteria under the control of controller 790 as described in more detail herein. An equalization tank may cycle from 810 FILL WAIT to 820 FILLING and back to 810 FILL WAIT if the process waste water stream 20 is discharged intermittently or if selection criteria for determining which equalization tank to fill calls for using an alternate equalization tank.

In a preferred embodiment, only one of the three equalization tanks are in state 820 FILLING at a time and only one equalization tank is in state 850 DRAINING at a time. If plant 100 discharges process waste water 20 and there are no equalization tanks in either state 810 FILL WAIT or state 820 FILLING, controller 790 selectively changes the state of one of the equalization tanks, 720, 730, 740 to state 820 FILLING according to pre-determined selection criteria.

With reference to FIG. 1 in operation, process waste water 20 from plant 100 (reference FIG. 2) is delivered to pre-treatment system 110 via pipe 750. Under normal operation, i.e., not an exceptional plant discharge event, if more than one equalization tank is in the FILL WAIT state, the pH of the accumulated waste water in the equalization tanks via sensors 723, 733, 743 as applicable, is compared to the pH of the process waste water 20 as measured with sensor 751. Responsive to the comparison, controller 790 will first select the equalization tank wherein addition of the process waste water 20 to the accumulated waste water would move the pH of resultant combination closer to the target pH range. If the addition of the process waste water 20 to the accumulated waste water would move the resultant pH of the combined mixture for two or more equalization tanks closer to the target pH range, the controller selects the equalization tank with a pH furthest from the pH of the process waste water 20. If there is not equalization tank in the FILL WAIT state where the addition of process waste water 20 to the accumulated waste water in an equalization tank would move the resultant pH of the combined mixture closer to the target pH range, the equalization tank with the lowest fluid level is selected.

Upon selection of the equalization tank to transition from the FILL WAIT to the FILLING state, the controller will first open valve 721, 731, 741 as appropriate, and then close the valve 721, 731, 741 as appropriate, of the prior equalization tank that was in the FILLING state. This ensures one equalization tank is always available to received process waste water 20 from plant 10. If the fluid level of the equalization tank that had been filling is either above a pre-determined fill threshold, or the total time the equalization tank has been accumulating fluid is longer than a retention time threshold the controller will change the state of said equalization to ADJUSTING PH. Otherwise, said equalization tank will transition to FILL WAIT.

The selected equalization tank will transition to the FILL state and remain in the FILL state until one of the following conditions occurs:
1) Upon receiving a signal that the fluid level in the current FILLING equalization tank, as measured with level sensor 722, 732, 742 as appropriate, indicates the tank level is at or above a fill level, controller 790 transitions the current FILLING equalization tank to the ADJUSTING PH state after transitioning a second equalization tank to FILL.
2) Upon the controller 790 determining the retention time of the fluid in the current FILLING equalization tank has exceeded a retention time threshold, controller 790 transitions the current FILLING equalization tank to the ADJUSTING PH state after transitioning a second equalization tank to FILL.
3) Upon receiving a signal from pH sensor 751 sensor indicating the pH of the process waste water 20 has changed such that further addition of the process waste water 20 to a second equalization tank currently in the FILL WAIT state would be more beneficial, controller 790 transitions the second equalization tank to FILL and the equalization tank to FILL WAIT.

Upon entering the PH ADJUSTING state, controller 790 closes valve 721, 731, 741 as appropriate. Controller 790 adjusts the pH of the accumulated waste water in the PH ADJUSTING equalization tank to the target pH range as measured via a signal from pH sensor 722, 732, 742 by appropriately dosing with acid using pumps 727a, 737a, 747a, as appropriate, or with base using pumps 727b, 737b, 747b as appropriate. When the pH is in the target range, controller 790 transitions the current ADJUSTING PH to the DRAIN WAIT state.

If two or more equalization tanks are in the DRAIN WAIT state, controller 790 will transition the equalization tank with the highest fluid level to the DRAIN state unless the retention time of the fluid in the second DRAIN WAIT equalization tank has exceeded a retention time threshold, in which case controller 790 transitions the second DRAIN WAIT equalization tank to DRAIN.

Upon transitioning an equalization tank to DRAIN, controller 790 opens valve 726, 736, 746 as appropriate and delivers process waste water 21 to settling tank 130 via influent delivery system 120. The current DRAIN equalization tank remains in the DRAIN state until the fluid level, as measured by fluid level sensor 722, 732, 742 as appropriate, is below a predetermine lower threshold. When the fluid level of the current DRAIN equalization tank is below the lower threshold, controller 790 closes valve 726, 736, 746 as appropriate and transitions the equalization tank to the FILL WAIT state.

From the foregoing description it will be apparent that there has been provided an improved method and system for pre-conditioning waste water prior to further treatment by a waste water treatment system. Variations and modifications of the herein described method and system in accordance with the present application will undoubtedly suggest themselves to those skilled in this art. Accordingly, the foregoing description should be taken as illustrative and not in a limiting sense.

What is claimed is:

1. A method to condition influent waste water, the method comprising:
establishing a target pH;
accumulating said waste water in a first equalization tank and a second equalization tank;
measuring the fluid level and pH of said first equalization tank accumulated waste water and the fluid level and pH of said second equalization tank accumulated waste water;
measuring the pH of said influent waste water;
adding said influent waste water to said first equalization tank if the fluid level in said first equalization tank is below a first threshold and the resultant pH from combining said influent waste water with said first equalization tank accumulated waste water would be closer to the target pH than the resultant pH from combining said influent waste water with said second equalization tank accumulated water; or,
adding said influent waste water to said second equalization tank if the fluid level in said second equalization tank is below a second threshold; or,
adding said influent waste water to said first equalization tank if the first fluid level is less than the second fluid level; or,
or adding said influent waste water to said second equalization tank.

2. The method of claim 1 further comprising the step of adjusting the pH of the first equalization tank accumulated water to the target pH if said fluid level in said first equalization tank is above a third threshold.

3. The method of claim 1 further comprising the step of adjusting the pH of the second equalization tank accumulated water to the target pH if said fluid level in said first equalization tank is above a fourth threshold.

4. The method of claim 1 further comprising the step of halting the accumulation of said waste water in said first equalization tank if said fluid level in said first equalization tank is above a fifth threshold.

5. The method of claim 1 further comprising the step of halting the accumulation of said waste water in said second equalization tank if said fluid level in said second equalization tank is above a sixth threshold.

6. The method of claim 1 wherein the target pH is a range with a lesser value and a greater value.

7. The method of claim 1 further comprising the steps of:
measuring a property of said waste water;
establishing a target range for the value of said property, said target range having a lesser value and a greater value,
adding the waste water to a designated tank if said value of said property is greater than said greater value.

8. The method of claim 7, wherein the designated holding tank is one of said first equalization tank and said second equalization tank.

9. The method of claim 7 further comprising the step of adding the waste water to a designated tank if said value of said property is less than said lesser value.

10. The method of claim 7, wherein the designated holding tank is one of said first equalization tank and said second equalization tank.

11. The method of claim 7 wherein the property is a property in the group consisting of biological oxygen demand, chemical oxygen demand, total organic carbon, pH, total suspended solids, turbidity, temperature, and conductivity.

12. A method to accumulate waste water for further processing, the method comprising:
starting the accumulation of said waste water in a first equalization tank at a first time and the accumulation of said waste water in a second equalization tank at a second time;
measuring the fluid level and pH of said first equalization tank accumulated waste water and the fluid level and pH of said second equalization tank accumulated waste water;
establishing a target pH;
measuring the pH of said waste water;
adding said waste water to said first equalization tank and said second equalization tank according to decision criteria intended to adjust the pH of said first equalization tank accumulated waste water and said second equalization tank accumulated waste water to a value near the target pH;
monitoring a first holding time calculated as the current time minus the first time and halting the accumulation of said waste water in said first equalization tank if said first holding time exceeds a first time threshold.

13. The method of claim 12 further comprising monitoring a second holding time calculated as the current time minus the second time and halting the accumulation of said waste water in said second equalization tank if said second holding time exceeds a second time threshold.

14. A method to condition influent waste water, the method comprising:
establishing a target pH range having a lesser value and a greater value;
accumulating said waste water in a plurality of equalization tanks;
measuring the fluid level and pH of accumulated waste water in a first equalization tank and the fluid level and pH of accumulated water in a second equalization tank;
measuring the pH of said influent waste water;
adding said influent waste water to said first equalization tank if the fluid level in said first equalization tank is below a first threshold and the resultant pH from combining said influent waste water with said first equalization tank accumulated waste water would be closer to the target pH range than the resultant pH from combining said influent waste water with said second equalization tank accumulated water; or,
adding said influent waste water to said second equalization tank if the fluid level in said second equalization tank is below a second threshold; or,
adding said influent waste water to said first equalization tank if the first fluid level is less than the second fluid level; or,
or adding said influent waste water to said second equalization tank.
